(19) United States
(12) Patent Application Publication
(10) Pub. No.: US 2011/0112741 A1
(43) Pub. Date: May 12, 2011

(54) ELECTRIC PARKING BRAKE FOR VEHICLE

(75) Inventor: Wook Jin CHOI, Seoul (KR)

(73) Assignee: MANDO CORPORATION

(21) Appl. No.: 12/943,594

(22) Filed: Nov. 10, 2010

(30) Foreign Application Priority Data
Nov. 10, 2009 (KR) 10-2009-107833

(51) Int. Cl. F16D 65/21; F16H 1/06

(52) U.S. Cl. 701/70; 74/414

(57) ABSTRACT

Disclosed is an electric parking brake. The electric parking brake includes driving motor generating rotational force, a driving gear formed at a driving shaft of the driving motor, a driven gear directly coupled with the driving gear, and a spindle coupled with the driven gear to linearly move by receiving the rotational force of the driving motor through the driven gear when the driving motor is driven. The structure of the gears transferring the rotational force of the driving motor is simplified as the driving gear and the driven gear, so that the installation space for the gears is reduced, thereby reducing the size of the electric parking brake.

This application claims the benefit of Korean Patent Application No. 10-2009-0107833 filed on Nov. 10, 2009, in the Korean Intellectual Property Office, the disclosure of which is incorporated herein by reference.

### BACKGROUND

1. Field

The disclosure relates to an electric parking brake, and more particularly to an electric parking brake capable of improving the structure of various components, such as a driving motor generating driving force, a gear transferring the driving force and a spindle converting the rotational movement into the linear movement.

2. Description of the Related Art

In general, a parking brake is used to keep a vehicle in a stop state. Recently, an electric parking brake (EPB) has been developed to keep the vehicle in the stop state by rotational force generated from a driving motor.

As shown in FIG. 1, an electric parking brake according to the related art includes a driving motor 1 generating rotational force, a reduction device 2 connected to the driving motor 1 to generate a toque higher than a toque generated from the driving motor 1, and a spindle 3 moving back and forth while rotating by receiving the rotational force from the reduction device 2.

The spindle 3 is connected to a brake installed at a wheel through a parking cable in such a manner that the braking operation of the brake installed at the wheel can be performed or released according to the movement of the spindle 3.

The reduction device 2 includes a driving gear 2a rotated by the driving motor 1, a driven gear 2c into which the spindle 3 is inserted, and a plurality of intermediate gears 2b engaged with the driving gear 2a and the driven gear 2c to transfer the driving force of the driving gear 2a to the driven gear 2c.

The electric parking brake must have a compact size such that the electric parking brake can be easily installed in the vehicle. However, the electric parking brake according to the related art is provided with the reduction device 2 including a multi-step gear array, so the size of the electric parking brake is enlarged.

### SUMMARY

Accordingly, it is an aspect of the disclosure to provide an electric packing brake having a compact size.

Additional aspects and/or advantages of the disclosure will be set forth in part in the description which follows and, in part, will be apparent from the description, or may be learned by practice of the disclosure.

The foregoing and/or other aspects of the disclosure are achieved by providing an electric parking brake including a driving motor generating rotational force, a driving gear formed at a driving shaft of the driving motor, a driven gear directly coupled with the driving gear, and a spindle coupled with the driven gear to linearly move by receiving the rotational force of the driving motor through the driven gear when the driving motor is driven.

According to the disclosure, the electric parking brake further includes a manipulation button, a detection sensor detecting current applied to the driving motor or counting an RPM of the driving motor, and an electronic control unit controlling an overload of the driving motor and braking force by receiving a manipulation signal of the manipulation button and information detected by the detection sensor.

As described above, according to the electric parking brake of the disclosure, since the structure of the gear transferring the rotational force of the driving motor to the spindle can be simplified, the installation space for the gear can be reduced so that the size of the electric parking brake can be reduced.

### BRIEF DESCRIPTION OF THE DRAWINGS

These and/or other aspects and advantages of the disclosure will become apparent and more readily appreciated from the following description of the embodiments, taken in conjunction with the accompanying drawings of which:

FIG. 1 is a perspective view showing an electric parking brake according to the related art;

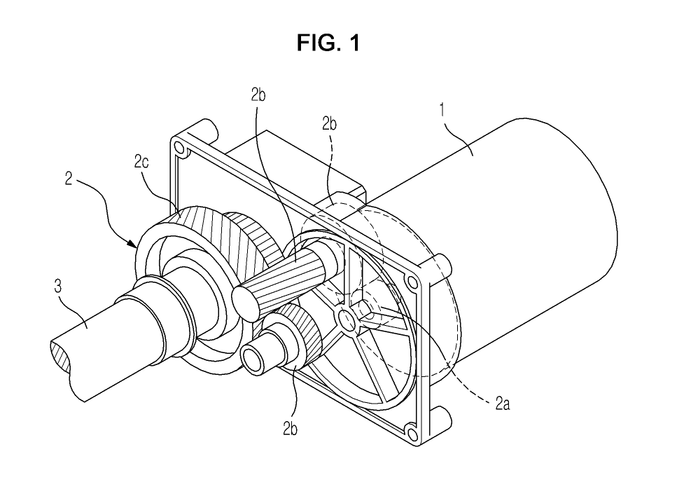

FIG. 2 is a perspective view showing a part of a vehicle equipped with an electric parking brake according to the disclosure; and

FIG. 3 is a perspective view showing an electric parking brake according to the disclosure.

### DETAILED DESCRIPTION OF THE EXEMPLARY EMBODIMENTS

Reference will now be made in detail to the embodiments of the disclosure, examples of which are illustrated in the accompanying drawings, wherein like reference numerals refer to the like elements. The embodiments are described below to explain the disclosure by referring to the figures.

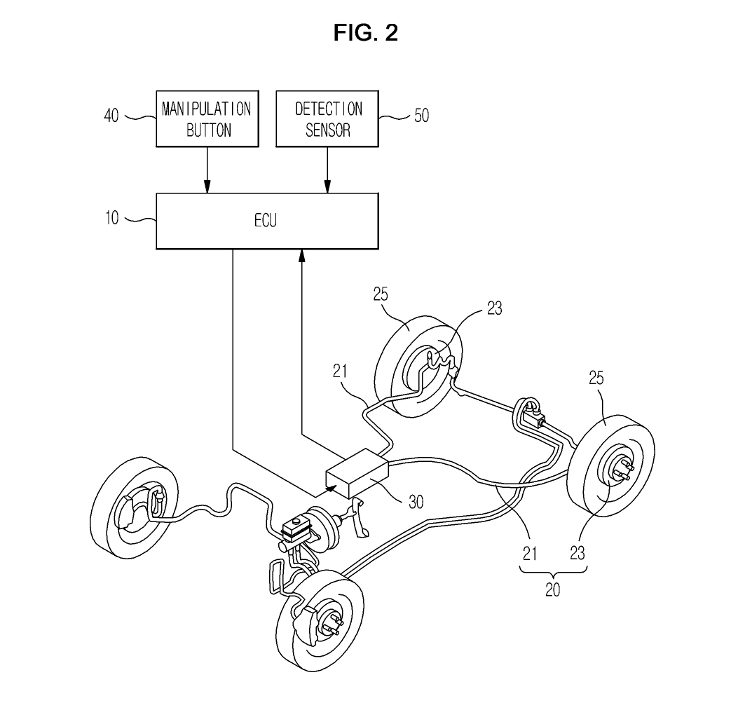

As shown in FIG. 2, an electric parking brake according to the disclosure includes an electronic control unit (ECU) 10 for generating control signals by receiving a manipulation signal of a manipulation button 40 and various information related to the parking operation, an actuator assembly 30 for supplying or releasing the braking force according to the control of the ECU 10, and a brake assembly 20 for braking wheels 25 according to the operation of the actuator assembly 30.

As a user operates the manipulation button 40, an auto-parking mode setting signal is transmitted to the ECU 10. That is, if the manipulation button 40 is turned on, a parking mode or a non-parking mode is automatically set according to the state of the vehicle.

The brake assembly 20 includes parking cables 21 receiving axial force from the actuator assembly 30 and wheel cylinders 23 braking the wheels 25 by holding wheel discs (not shown) installed at the wheels 25 as pulling force of the parking cables 21 is applied thereto.

The ECU 10 receives and analyzes the manipulation signal of the manipulation button 40 and various information related to the parking operation and determines whether the present mode is the parking mode or the non-parking mode. In addition, the ECU 10 controls the operation of the actuator assembly 30 and the brake assembly 20 based on the determination result.

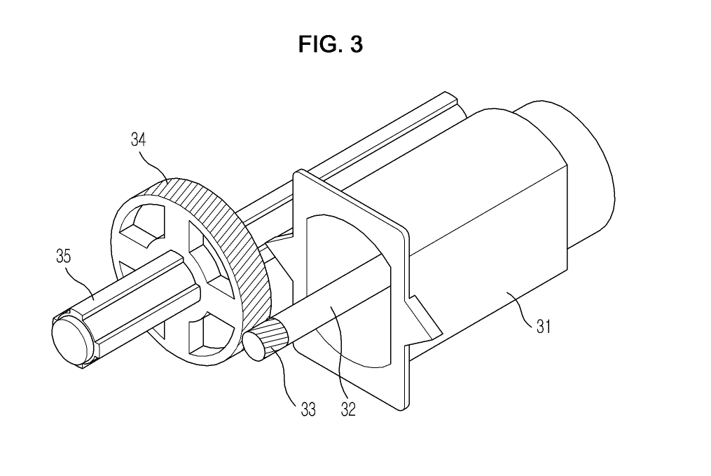

If a detection sensor 50 detects the overload of a driving motor 31 (see, FIG. 3) of the actuator assembly 30, the ECU 10 controls the operation of the driving motor 31 to prevent the driving motor 31 from being overloaded.

During the parking mode or the non-parking mode, the ECU 10 calculates the tension of the parking cable 21 of the brake assembly 20 based on the current applied to the driving motor 31 and acquires operational stroke data of the parking cable 21 corresponding to the RPM of the driving motor 31 to correct the tension of the parking cable 21. In addition, the ECU 10 controls the operation of the driving motor 31 based on the tension of the parking cable 21 to predict the braking force of the brake assembly 20.

At this time, the detection sensor 50 detects the current applied to the driving motor 31 or counts the RPM of the driving motor 31 when the driving motor 31 is driven in the forward or reverse direction, and transmits the result value to the ECU 10.

As shown in FIG. 3, the actuator assembly 30 includes the driving motor 31, a driving gear 33 formed at a driving shaft 32 of the driving motor 31, a driven gear 34 engaged with the driving gear 33, and a spindle 35 moving back and forth by the rotational force of the driven gear 34.

Upon the operation of the manipulation button 40, the driving motor 31 is driven in the forward or reverse direction under the control of the ECU 10, thereby providing the braking force or the releasing force to the brake assembly 20.

As described above, the driving gear 33 is formed by processing the driving shaft 32 of the driving motor 31. The driven gear 34 is engaged with the driving gear 33 to receive the rotational force of the driving motor 31 and coupled with the spindle 35 to move the spindle 35.

The spindle 35 is coupled with the driven gear 34 and linearly moves according to the rotation of the driven gear when the driving motor 31 is driven.

The spindle 35 is connected to the parking cable 21. One end of the parking cable 21 is connected to the spindle 35 and the other end of the parking cable 21 is connected to the wheel cylinders 23 installed at the wheels. In detail, the parking cable 21 is connected to an end portion of the spindle 35 to supply the braking force while being pulled or released according to the movement of the spindle 35.

Therefore, according to the embodiment of the disclosure, the driving gear 33 is formed at the driving shaft 32 of the driving motor 31 and the driven gear 34 directly connected to the driving gear 33 is directly coupled with the spindle 35. Thus, different from the electric parking brake having the multi-step gear array according to the related art, the installation space for the gears 33 and 34 transferring the rotational force to the driving motor 31 can be reduced.

That is, according to the embodiment of the disclosure, the installation space for the gears 33 and 34 can be reduced, so that the size of the electric parking brake can be reduced.

Although few embodiments of the disclosure have been shown and described, it would be appreciated by those skilled in the art that changes may be made in these embodiments without departing from the principles and spirit of the disclosure, the scope of which is defined in the claims and their equivalents.

What is claimed is:

1. An electric parking brake comprising:
a driving motor generating rotational force;
a driving gear formed at a driving shaft of the driving motor;
a driven gear directly coupled with the driving gear; and
a spindle coupled with the driven gear to linearly move by receiving the rotational force of the driving motor through the driven gear when the driving motor is driven.

2. The electric parking brake of claim 1, further comprising a manipulation button, a detection sensor detecting current applied to the driving motor or counting an RPM of the driving motor, and an electronic control unit controlling an overload of the driving motor and braking force by receiving a manipulation signal of the manipulation button and information detected by the detection sensor.
